(19) United States
(12) Patent Application Publication
(10) Pub. No.: US 2005/0150152 A1
(43) Pub. Date: Jul. 14, 2005

(54) Whale safe groundline

(76) Inventor: Norman L. Holy, Yardley, PA (US)

Correspondence Address: John J Simkanich;Paul & Paul, 2900 Two Thousand Market Street, Philadelphia, PA, 19103, US

(21) Appl. No.: 11/018,137

(22) Filed: Dec. 21, 2004

Related U.S. Application Data
(60) Provisional application No. 60/533,069, filed on Dec. 29, 2003.

(51) Int. Cl. A01K 69/00

(52) U.S. Cl. 43/100

(57) ABSTRACT

A whale-safe goundline rope for attachment to undersea traps and seagoing buoys. This rope is made of melt-processable polymers having filler particulate distributed uniformly throughout the polymer, prior to it being extruded into a fiber or yarn. The manufacturing process generates a hollow rope, with that being a rope made from hollow fibers or yarn. The filler particulate is sufficient to provide a rope with negative buoyancy.

### RELATED APPLICATIONS

This application claims priority of U.S. provisional application No. 60/533,069, filed Dec. 29, 2003, titled Whale-Safe Groundline, which is incorporated herein by reference in its entirety.

### BACKGROUND OF THE INVENTION

The present invention relates to rope, particularly rope used in sea water to secure buoys and lobster and crab traps and the like.

“Groundline” or “mainline” refers to the rope used between traps (also called pots), typically in the lobster, crab, or eel fisheries.

Whales encounter such ropes in the oceans of the world and often die as a consequence of this encounter. The number lost is in the hundreds each year, worldwide. The rope wraps around flippers, the body, the head (especially the rostrum), the tail (fluke) or is caught in the baleen. The danger extends beyond whales to other members of the cetacean family (cetaceans consist of whales, dolphins, and porpoises).

When a whale or other cetacean is entangled in rope, there is a high probability that the animal will die. Death can come from the rope cutting into the animal, all the way through the flesh, with the consequence of the animal bleeding to death. More commonly, the wound becomes infected and the animal dies. Right whales, numbering only 350 in the North Atlantic in 2003, are vulnerable to groundlines since they dive to the depth of the copepods and feed with their mouths open. This type of feeding exposes them to the possibility of taking a rope into their mouths, and the rope catching in their baleen.

Of the eight right whales known to have been entangled, in 2002, in the North Atlantic, only one was freed by rescuers cutting the entangled ropes. The fate of the other seven are unknown, but it's highly likely that many of these whales died. As right whales are on the Endangered Species list, any entanglements have long-term consequences regarding the survivability of the species.

No species of whale is exempt from entanglements in rope. For example, in 2003, some twenty-three humpbacks were entangled in rope in the Gulf of Maine. A significant fraction of these entanglements occurred with groundlines.

An entangled animal is difficult to find in the vast ocean, and even if rescuers are able to locate the animal, it is very difficult to approach close enough to cut the ropes. Even when the animal can be located and approached, the rope may have cut into the animal so far that it cannot be severed. The timeframe from entanglement to death of the whale varies depending on the type of entanglement, but if the rope is wrapped around the rostrum, the whale typically dies in about two months.

Typically, a string or “trawl” of lobster traps consists of 2-20 wire traps connected together by rope going from one trap to another. This rope is commonly made of polypropylene, which has a density of less than that of seawater and thus is buoyant. The rope loops upward and floats in a large loop in the water and it is very easy for a whale to become entangled. Often whale becomes entangled about the head, or in the baleen, suggesting that the whale was feeding and thus had its mouth open. The magnitude of the danger which groundlines pose to all whales and other cetaceans is illustrated by the fact that there are approximately 10 million lobster traps in the Gulf of Maine, alone. These traps and the accompanying groundlines are in the water for about eight months of the year.

The danger of groundlines to whales comes from the ropes floating up into a column of uprising water into which the cetaceans swim or dive to feed. To get around this problem the National Marine Fisheries Service has called for the use of rope with a density greater than that of seawater (1.02 g/cc) to be used as groundline. The theory is that a rope that is at or very close to the bottom will have reduced risk of snaring a whale or other cetacean. Several products are now sold for use as “sinking” or “neutral-buoyant” rope. These are made in one of three ways: they are mixture of polypropylene and polyester yarns, pure polyester, or pure nylon. These fibers are invariably assembled into “twisted” rope.

One problem with the “sinking” and “neutral-buoyant” ropes is that they wear out much faster, than when they are manufactured to float off of the bottom. Wear is rapid regardless of whether the ropes contact sand, mud or hard bottom. On a hard bottom, the wear on the rope is from the outside inward as the rope frays as it moves in the tides and currents. On sand or mud, wear comes mostly from particles becoming embedded within the twists of the rope and then fraying the rope from the inside. A rope that lasts for five (5) years floating up into a water column will only last for two (2) years when it is contact with the bottom. This much shorter life for a groundline, which rests on the bottom is a cost issue for trap fishermen.

What is needed is a rope that does not cut into the animal as rapidly, extending the period for when the animal may either shed the rope or be freed by rescuers.

What is further needed is a negative buoyancy rope, lower cut incidence rope.

What is also needed is a negative buoyancy rope that lasts considerably longer than two years.

### SUMMARY OF THE INVENTION

The object of the present invention is to provide a negative buoyancy rope which has greater wear resistance when resting on the ocean bottom and which is less likely to cut into a whale or other cetacean when the animal gets caught up in the rope. To satisfy these objectives a fiber or yarn was developed from which a rope is twisted or otherwise made. The resultant rope has several improvements over what is currently available.

To achieve a sinking rope with negative buoyancy, inorganic fillers with higher specific gravity are loaded, i.e., imbedded in the fibers or yarn from which the rope is made. Melt-processable polypropylene is used for the fiber or yarn, although polyethylene, nylon, or polyester would also be acceptable. Into the polypropylene is blended a particulate filler, so that the resultant density will be greater than that of seawater. One example, a preferred combination, is 85-70% polypropylene (by weight) and 15-30% (by weight) barium sulfate. The resultant rope will have a feel very much like the current floating rope, and thus fishermen could accept the rope easily as it can be handled by their equipment similarly to existing groundline rope.

Previous rope becomes looser and more limp as it is worked. This previous rope when subjected to abrasion from twisting against bottom objects, and sand abrasion attacking loosened stands begins to wear out and fail. In the present invention, the filler material makes the filled rope only slightly stiffer, when the rope is new. However, the filler material inhibits the rope from becoming looser and more limp as it is worked. Therefore, when a filled rope is made into a negative buoyancy rope, which lays along the bottom and is normally subjected to more mechanical working from changes in currents, the shifting of sand, and pulling abrasion against rocks, the rope of the present invention resists mechanical working and resists having stands loosened, therefore is more wear resistant.

In the present invention, the filled fibers or yarn could be twisted into rope or put together in other ways to form rope. The hollow strands will maintain their longitudinal strength, but when subjected to lateral forces will tend to flatten without breaking. In this way there is a reduction in the rate that the rope cuts into the entangled animal.

The hollow rope of the present invention will provide another advantage in protecting whales. Whales often become entangled while feeding with their mouths open. Ropes become caught in their baleen. The hollow fiber rope will tend to slide through the baleen. Michael Moore and his group at Woods Hole has discovered that hollow rope slides through baleen better than twisted rope (Right Whale Consortium Meeting, Nov. 4-5, 2003, New Bedford, Mass.).

Useful fillers include talc, silica, barium sulfate, calcium sulfate, clay, diatomatious earth, silica, alumina, kaolin, carbon, aluminum hydroxide, titanium dioxide, glass, wollastonite, organosilicone powders, sand, calcium silicate, and magnesium silicate calcium silicate, iron oxides, aluminum silicate, and mixtures thereof.

### BRIEF DESCRIPTION OF THE DRAWINGS

The features, advantage and operation of the present invention will become readily apparent and further understood from a reading of the following detailed description with the accompanying drawings, in which like numerals refer to like elements, and in which:

FIG. 1 is a block diagram of a three stranded “hawserlaid” type rope of filled polymer material of the present invention;

FIG. 2 is a block diagram a nine stranded hollow rope of the present invention;

FIG. 3 is a block diagram of equipment and product flow for manufacturing filled polymer fiber and yarn;

FIG. 4 is a block diagram of the process steps for making solid and hollow (core) filled polymer rope of the present invention; and

FIG. 5 is a pictorial view of open ocean floating groundline for buoys and traps.

### DETAILED DESCRIPTION OF THE INVENTION

The present invention is an improved rope for use as an open ocean groundline, having a negative buoyancy and enhanced abrasion resistance and resistance to sand infiltration. This rope is intended to reduce or eliminate the floating of groundline which occurs in the open ocean, FIG. 5, and the floating of groundline in water columns frequented by whales and other cetaceans when feeding.

The rope is made from a melt-processed polymer such as a polyolefin, a polyamide, a polyester, a polyaramide, or a coated compound material of any of these.

The innate mechanical, chemical and ultraviolet (UV) properties, including tensile strength and breakdown from mechanical working will vary depending upon the polymer chosen. Not all of these polymers are suitable for long-term open ocean use or use with commercial fishing boat equipment.

The polymer is filled with a filler chosen from: talc, barium sulfate, barytes, calcium sulfate, clay, diatomatious earth, silica, alumina, kaolin, carbon, aluminum hydroxide, titanium dioxide, glass, wollastonite, organosilicone powders, sand, calcium silicate, and magnesium silicate calcium silicate, iron oxides, aluminum silicate, and combination mixtures of these.

These filler materials vary considerably in their chemical and physical properties and are not to be considered to give equivalent results. Some are hydrophobic, others anhydrous, others hydrophilic. Some are crystalline in two directions and amorphous in the third, others are crystalline in three directions, and even others are non-crystalline.

The specific filler material chosen will also affect the practical range of particle size for the filler. The combination of a particular polymer with a specific filler will not provide identical results as different polymer with a different filler. What is uniform across the choices is that a filled melt-processes polymer will have a higher specific gravity and be more wear resistant than the non-filled version of the polymer.

Polyester rope filled with particles of any of barium sulfate, barytes, silica, calcium sulfate, alumina, or a silicate of calcium, magnesium, or aluminum appear to give excellent results. Particle sizes in the range of about 0.25 to about 20 microns with a size deviation of plus to minus 25% also give excellent results.

The resultant rope product of the present invention has a specific gravity of greater than 1.03 g/cc (grams per cubic centimeter). Moreover, the rope product does not have its strands loosen or loose its initial “starch” as easily as non-filled polymer rope. The wear-resistance to abrasion against objects is enhanced.

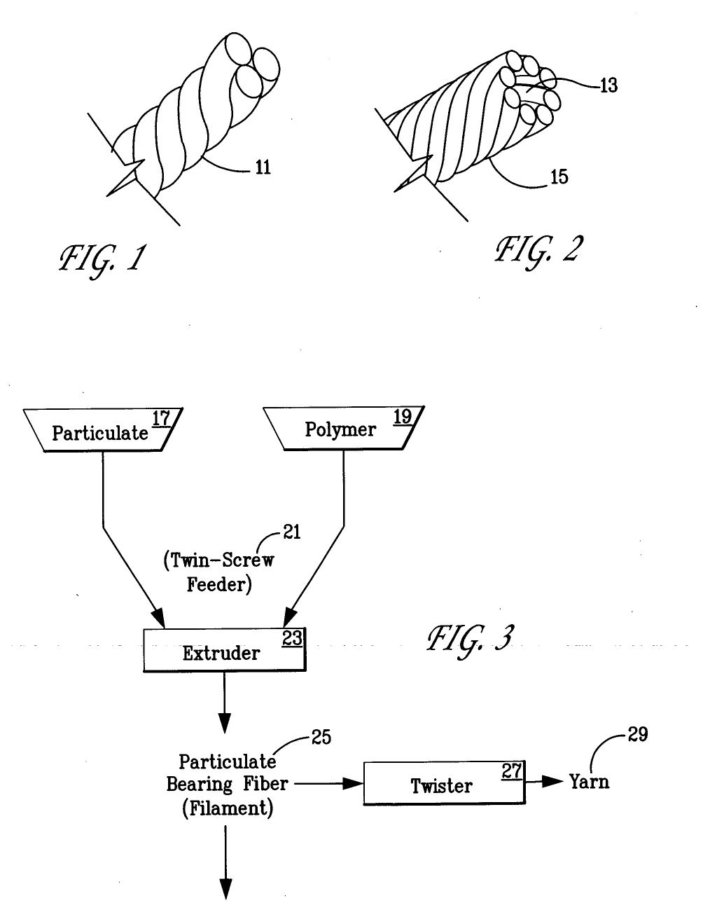

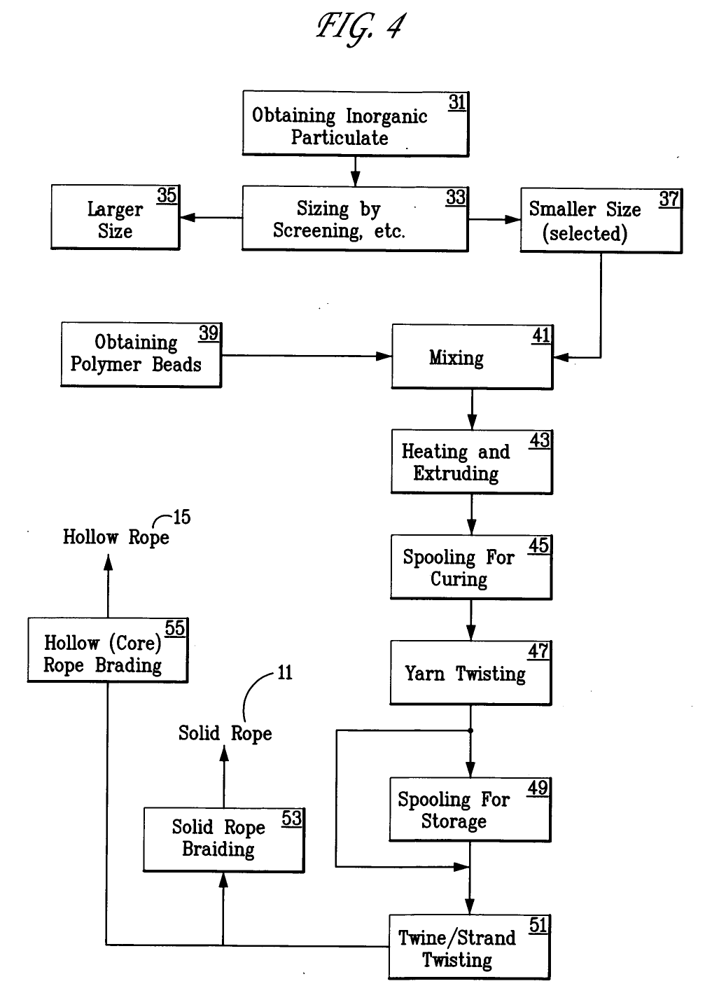

A mixture of filler material and polymer beads is heated and extruded into fiber or yarn from which a twine or strand is twisted. Rope is then braided from the strand material. The rope can be solid as shown in the three strand rope 11 of FIG. 1 or it can been braided around a hollow form to produce a hollow core 13 rope shown in the nine strand rope 15 of FIG. 2.

Both ropes FIGS. 1 and 2 have a negative buoyancy, with specific gravity of greater than 1.03 g/cc. The hollow rope 15 of FIG. 2 will flatten when subjected to lateral forces. In a flattened state the rope 15 will not cut into the flesh or beleen of a whale easily. This will reduce injury upon entanglement or upon collision.

The selected filler particles are loaded into a process feeder bin 17, FIG. 3, while polymer beads are loaded into a feeder bin 19. In order to control the mixture ratio, a twin screw feeder 21 provides a powered draw of raw materials from each bin 17, 19 and force feeds the extruder 23. This feeder 21 also mixes the two ingredients from the bins 17, 19 in a homogeneous dry mix. This mix is fed to an extruder 23, which heats the polymer into a melt and creates a pressure to eject the filled polymer melt from the extruder 23. This is typically accomplished with screw feeds within the extruder itself. Depending upon the selection of commercial equipment this process steps can be carried out in one machine or is several machines lined-up in a production line.

The fiber strands 25 exiting the extruder 23 are either spooled for storage for later use, or fed into a twisting machine 27, which makes a yarn 29.

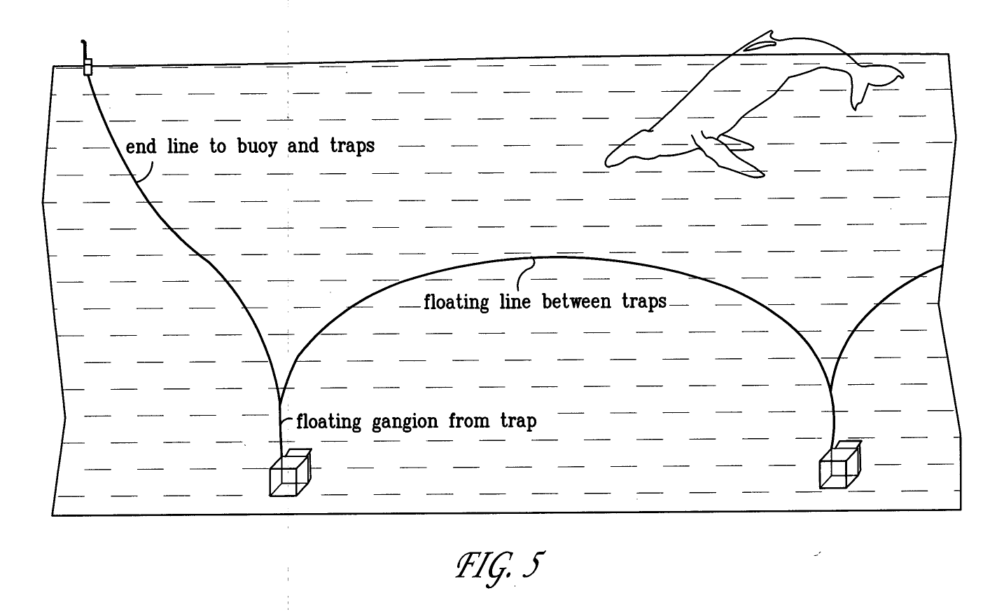

The process for manufacturing the groundline rope of the present invention are illustrated in FIG. 4. First the, preferable inorganic filler particles are obtained 31. Then the filler material is sized by screening or other means 33. Out of specification sizes are collected for reprocessing or discarding. The selected size of filler particles are also collected 37. This sizing can be in a range, such as 0.25 to 100 microns, or in a narrower range, such as 15 microns, plus or minus 3 microns. This latter selection equates to 12 to 18 microns selection.

The desired polymer beads are obtained 39 and dry mixed 41 with the filler particles. This dry mixture is then heated and extruded 43 into a fiber or filament which is then spooled 45 for movement to another work station or for movement to storage for curing.

The filaments are twisted into a yarn 47. This twisting 47 occurs at ambient temperatures and at various humidity levels, depending upon the mechanical working required and the polymer material being worked. The yarn is either spooled for storage 49, or sent to a strand twisting station 51 for twisting into a strand.

The strand product is fed to a solid rope braiding station 53 or a hollow rope braiding station 55. An example of the solid rope 11 is shown in FIG. 1. An example of hollow rope 15 is shown in FIG. 2.

Many changes can be made in the above-described invention without departing from the intent and scope thereof. It is therefore intended that the above description be read in the illustrative sense and not in the limiting sense. Substitutions and changes can be made while still being with the scope of the appended claims.

1. A wear-resistant fiber, comprising:
a melt-processable polymer; and
a filler distributed uniformly in said fiber;
wherein said filler occupies between about 3% to about 15% by volume of the fiber; said filler having an average particle size in the range of about 0.25 microns to about 100 microns.

2. The wear-resistant fiber of claim 1, wherein said partial size of said filler is uniform to about plus or minus 15%, whereof the wear-resistance of said fiber is increased by at least about 25% compared with a like polymer fiber without said filler.

3. The wear-resistant fiber of claim 1, wherein the average particle size of said filler is in the range of about 0.25 to about 20 microns.

4. The wear-resistant fiber of claim 1, wherein said filler is selected from the group of: talc, silica, barium sulfate, barytes, calcium sulfate, clay, diatomatious earth, silica, alumina, kaolin, carbon, aluminum hydroxide, titanium dioxide, glass, wollastonite, organosilicone powders, sand, calcium silicate, and magnesium silicate calcium silicate, iron oxides, aluminum silicate, and combination mixtures of these.

5. The wear-resistant fiber of claim 1 wherein said filler is distributed in said fiber in an amount of about 10% to about 30% on a weight basis.

6. The wear-resistant fiber as recited in claim 4 wherein said filler is distributed is said fiber in an amount of about 10% to about 30% on a weight basis.

7. The wear-resistant fiber of claim 1, wherein said filler is barium sulfate, present in said melt-processable polymer in an amount of about 10 to about 30% by weight.

8. The wear-resistant fiber of claim 2, wherein said filler is barium sulfate, present in said melt-processable polymer in an amount of about 10% to about 30% by weight.

9. The wear-resistant fiber of claim 3, wherein said filler is barium sulfate, present in said melt-processable polymer in an amount of about 10% to about 30% by weight.

10. The wear-resistant fiber of claim 1, wherein said filler is talc, present in said melt-processable polymer in an amount of about 10% to about 30% by weight.

11. The wear-resistant fiber of claim 1, wherein said filler is silica, present in said melt-processable polymer in an amount of about 10 to about 30% by weight.

12. The wear-resistant fiber of claim 1, wherein said melt-processable polymer is selected from the group consisting of polypropylene, polyethylene, nylon, polyester, and combinations of these.

13. A method of making a fiber or yarn having increased wear-resistance, comprising the steps of:
(a) making a uniform blend of at least about 10% by weight of:
a filler having a particle size in the range of about 0.25 microns to about 100 microns, and
a melt-processable polymer selected from the group consisting of polyethylene, polypropylene, nylon, polyester, and a blend of these; and
(b) extruding said uniform blend into a fiber or yarn having a density greater than 1.03 g/cc, wherein the wear-resistance is increased by at least about 25% compared with a fiber or yarn made from said like melt-processable polymer without said filler.

14. The method of claim 13, wherein said filler is of inorganic material.

15. The method of claim 14, wherein said inorganic filler is selected from the group of: talc, barium sulfate, barytes, calcium sulfate, clay, diatomatious earth, silica, alumina, kaolin, carbon, aluminum hydroxide, titanium dioxide, glass, wollastonite, organosilicone powders, sand, calcium silicate, and magnesium silicate, iron oxides, aluminum silicate, and combination mixtures of these.

16. The method of claim 15 wherein said extruding step produces a hollow fiber or yarn.

17. A method of making a rope having increased wear-resistance, comprising the steps of:
(a) making a fiber or yarn according to the method of claim 13; and
(b) fabricating said fiber or yarn into a rope; and
(c) evaluating said rope for an increase in wear-resistance of at least about 25% compared with a rope made from said like melt-processed polymer without said filler.

18. The method of making rope of claim 17, wherein said fabricating step includes braiding said fiber or yarn into a hollow rope, having a hollow core or center.

19. A method of reducing deaths in whales and other cetaceans by cutting or entanglement when in contact with an rope, by selecting said a rope with (a) a density of greater than 1.03 g/cc, (b) and wherein the yarn and stands of said rope contain between 10-30% by weight of inorganic filler.

20. The method of reducing deaths of claim 19, wherein said rope is stranded with a hollow center.

21. The method of reducing deaths of claim 20, wherein said inorganic filler is selected from the group of: talc, barium sulfate, barytes, calcium sulfate, clay, diatomatious earth, silica, alumina, kaolin, carbon, aluminum hydroxide, titanium dioxide, glass, wollastonite, organosilicone powders, sand, calcium silicate, and magnesium silicate, iron oxides, aluminum silicate, and combination mixtures of these.

22. A whale-safe rope for use with fishing gear, comprising:
a rope of diameter between about 5/16 inches and about 2.0 inches that breaks between about 2500 lbs. and about 8000 lbs. of pulling tension; and
wherein said rope is made of fibers or yarn containing a filler of different density from the material from which said rope is made.

23. The whale-safe rope of claim 22, wherein said fibers or yarn filler is an inorganic material.

24. The whale-safe rope of claim 23, wherein said rope fibers or yarn are hollow.

25. The whale-safe rope of claim 24, wherein said inorganic filler is between about 10% to about 30% by weight.

26. The whale-safe rope of claim 25, wherein said inorganic filler is selected from the group of: talc, barium sulfate, barytes, calcium sulfate, clay, diatomatious earth, silica, alumina, kaolin, carbon, aluminum hydroxide, titanium dioxide, glass, wollastonite, organosilicone powders, sand, calcium silicate, and magnesium silicate, iron oxides, aluminum silicate, and combination mixtures of these.

27. The whale-safe rope of claim 26, wherein said rope fibers or yarn are made from a melt-processable polymer, and wherein said organic filler is particulate and uniformly distributed therein.

28. The whale-safe rope of claim 27, wherein said particulate is sized between about 0.25 microns and about 20 microns.

29. The whale-safe rope of claim 28, wherein said melt-processable polymer fibers or yarn are hollow, and wherein the specific gravity of the rope is greater than 1.03 g/cc.
